(19) United States
(12) Patent Application Publication
(10) Pub. No.: US 2013/0019518 A1
(43) Pub. Date: Jan. 24, 2013

(54) SMALL HIVE BEETLE TRAP ATTACHMENT FOR BEE HIVES

(71) Applicant: DAVID MILLER, Jackson, TN (US)

(72) Inventor: DAVID MILLER, Jackson, TN (US)

(21) Appl. No.: 13/188,278

(22) Filed: Jul. 21, 2011

(51) Int. Cl. A01M 1/10

(52) U.S. Cl. 43/107

(57) ABSTRACT

A beetle trap attachment for bee hives may include a body, a bait chamber attached to the body, an oil reservoir disposed adjacent to the bait chamber attached to the body, at least one spring action arm attached to the body and disposed outwardly from the body configured for attaching to a bee hive, and at least one slot configured for allowing beetles to enter the at least one slot, disposed on the body adjacent to the bait chamber. The beetle trap attachment may attach to a bee hive and capture beetles.

### CROSS REFERENCE TO RELATED APPLICATIONS

This application claims the benefit of priority of U.S. provisional application No. 61/327,865, filed Apr. 27, 2010.

### BACKGROUND OF THE INVENTION

The present invention generally relates to bee hives, and more particularly, to small hive beetle trap attachments for bee hives.

Current bee hives lack attachments for trapping insects.

As can be seen, there is a need for a small hive beetle trap attachment for bee hives.

### SUMMARY OF THE INVENTION

In one aspect of the present invention, a small hive beetle trap attachment may comprise a body; a bait chamber attached to the body; an oil reservoir attached to the body disposed adjacent to the bait chamber; a plurality of spring action arms configured for attaching to a bee hive frame, attached to the body and disposed outwardly from the body; and at least one slot configured for allowing beetles to enter the at least one slot, the at least one slot disposed on the body adjacent to the bait chamber.

These and other features, aspects and advantages of the present invention will become better understood with reference to the following drawings, description and claims.

### BRIEF DESCRIPTION OF THE DRAWINGS

FIG. 1 is a perspective view of a small hive beetle trap attachment for bee hives according to an exemplary embodiment of the present invention, shown in use;

FIG. 2 is a perspective view of the small hive beetle trap attachment for bee hives from FIG. 1 illustrating a bait chamber lid and an open beetle trap lid;

FIG. 3 is a perspective view of the small hive beetle trap attachment of FIG. 1 for bee hives illustrating the bait chamber lid in closed position and the beetle trap attachment lid in open position;

FIG. 4 is a perspective view of the small hive beetle trap attachment of FIG. 1 for bee hives illustrating the bait chamber lid and beetle trap attachment lid in closed position;

FIG. 5 is a top view of the small hive beetle trap attachment for bee hives of FIG. 1 illustrating the bait chamber lid and beetle trap attachment lid in open position;

FIG. 6 is a section view taken along line 6-6 in FIG. 5, with components opening tab, spring action arm, and finger omitted for clarity;

FIG. 7 is a section view taken along line 6-6 in FIG. 5, with opening tab, spring action arm and finger omitted for clarity and illustrating various positions of the bait chamber lid; and

FIG. 8 is a section view taken along line 6-6 in FIG. 5, with opening tab, spring action arm and finger omitted for clarity and illustrating various positions of the beetle trap attachment lid.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a beetle trap attachment for bee hives for trapping beetles.

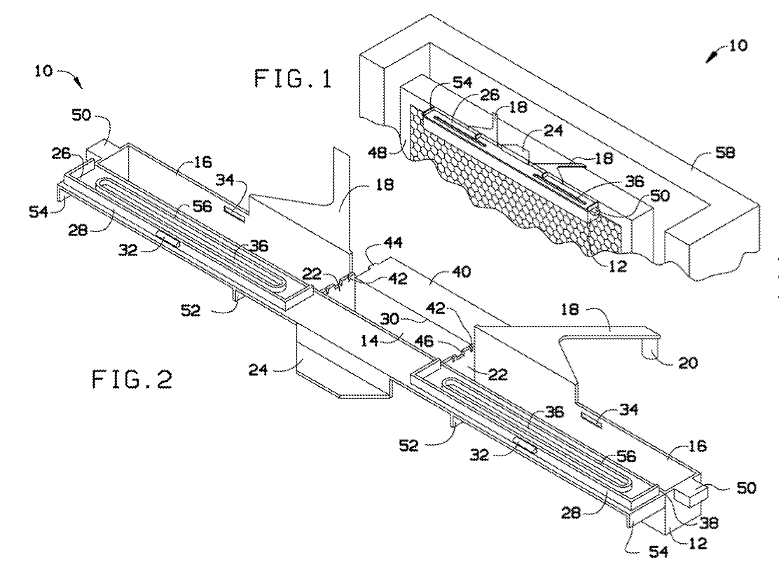

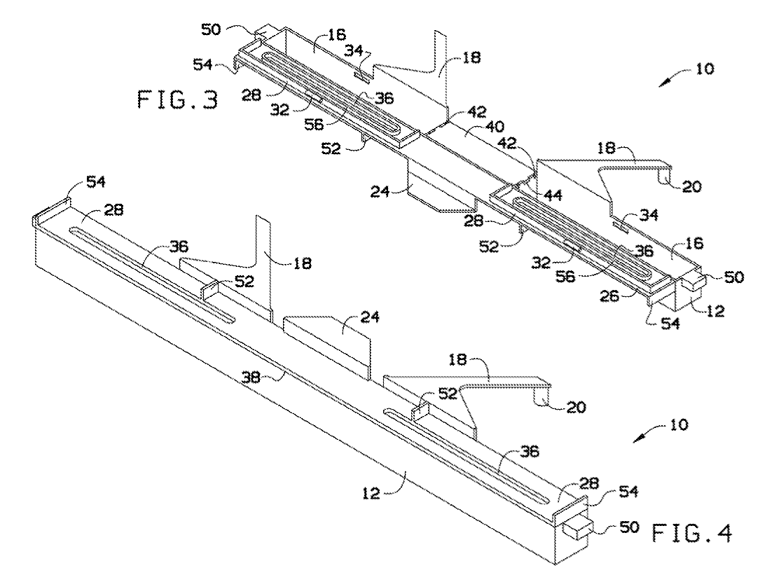

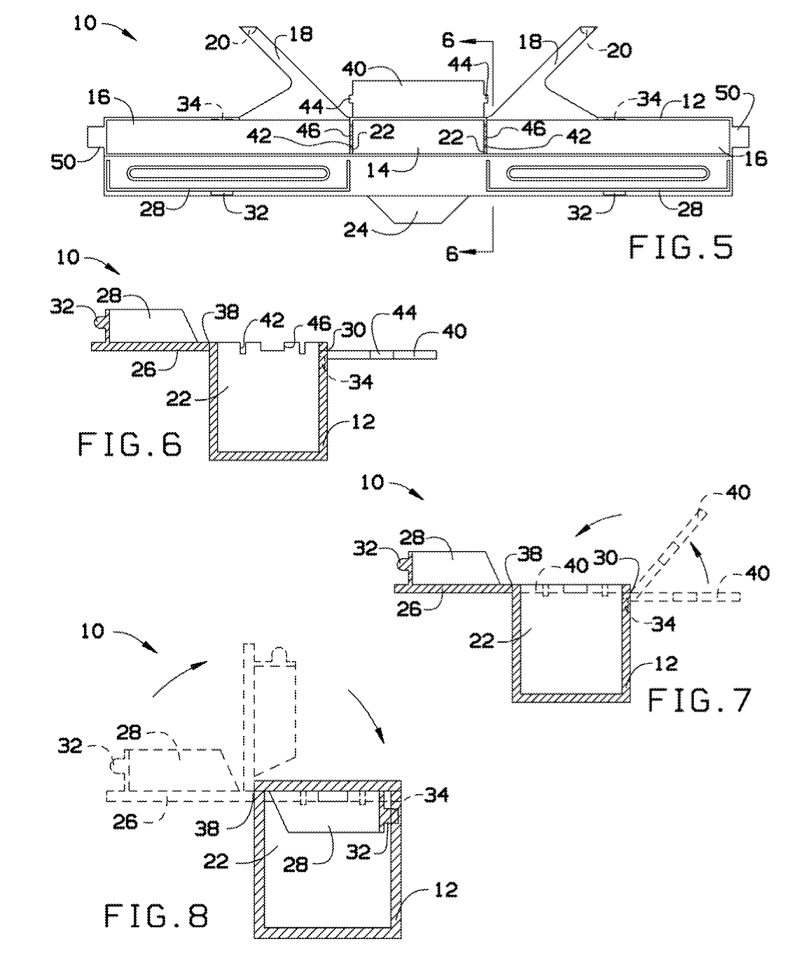

Now referring to FIG. 1-8a small hive beetle trap attachment 10 for bee hive frame 48 may include a body 12 that may support the beetle trap attachment 10. The small hive beetle trap attachment 10 may include a lid 26 with an opening tab 24 that may aid in opening the lid 26. A lid lip 28 on an underside of the lid 26 may prevent beetles from exiting the beetle trap attachment 10. The lid 26 may snap shut with a snap tab 32 on the lid 26 that snaps into an indentation 34 in the body 12 of the beetle trap attachment 10. The lid 26 may have slots 36 that may allow beetles to enter, but may prevent bees from entering the lid 26. The lid 26 may include a hinge 38 that may allow the lid 26 to open and close for reasons such as cleaning the small hive beetle trap attachment 10. The small hive beetle trap attachment 10 may include a tab 50 for lifting the small hive beetle trap attachment 10 from the bee hive frame 48. The small hive beetle trap attachment 10 may include a wall 52 for guiding beetles into the slots 36. A wall 54 may be included at the end of the small hive beetle trap attachment 10 lid 26 for creating a pocket 60, when a the small hive beetle trap attachment 10 is placed between bee hive frames 48 (additional frame not shown) or between the bee hive frame 48 and the wall 54, for beetles to gather in. The slots 36 may be configured at the center of the pocket 60. The small hive beetle trap attachment 10 may include a lip 56 around the inside of the slots 36 to prevent beetles from escaping the small hive beetle trap attachment 10. The small hive beetle trap attachment 10 may have a flat bottom such that the beetle trap attachment 10 may be placed on a flat surface without tipping over and spilling contents of the small hive beetle trap attachment 10.

In an exemplary embodiment, at least one spring action arm 18 may attach the small hive beetle trap attachment 10 to a hive 58. A finger 20 attached to the spring action arm 18 may further secure the small hive beetle trap attachment 10 to the bee hive 58. As an example, the spring action arm 18 may allow a bee hive frame 48 to be removed from the bee hive 58 with the small hive beetle trap attachment 10 still attached to the bee hive frame 48. The spring action arm 18 may hold the small hive beetle trap attachment 10 tight against the beehive frame 48 such that there is no gap between the small hive beetle trap attachment 10 and the bee hive frame 48 for beetles to hide in. In an exemplary embodiment, the spring action arms 18 may be offset such that the body 12 of the small hive beetle trap attachment 10 may be lower than the than a top surface of the bee hive frame 48. The spring action arms 18 may be at an angle from the bee hive frame 48 such that beetles are guided towards the small hive beetle trap attachment 10 as the beetles crawl along the bee hive frame 48.

In an exemplary embodiment, a bait chamber 14 with a bait chamber lid 40 may be attached to the body 12. As an example, living small hive beetles may be placed in the bait chamber 14. The scents of the live small hive beetles or alternatives baits such as honeycomb, pollen or fruit may attract other beetles into an oil reservoir 16 outside the bait chamber 14 where non-bait beetles may drown in oil. As an example, the bait chamber 14 may not contain oil. For example, non-toxic oil may be used. The oil reservoir 16 may be divided into 2 or more chambers by partitions 22 and the partition 22 walls may prevent oil in the oil reservoir 16 from spilling if the trap or bee hive is moved or tilted. The bait chamber may include a fume escape 42 which may allow scents of the bait beetles to escape. For example the bait chamber may have at least one fume escape that is sized such that living small hive beetles may be retained as bait to attract more of the beetles into the oil reservoir. The bait chamber lid 40 may include a hinge 30 that may allow the bait chamber lid 40 to be opened for adding bait beetles. The bait chamber lid 40 may include a bait chamber lid opening tab 44 for opening the bait chamber lid 40. The bait chamber opening tab 44 may rest in a bait chamber tab mate 46 when the bait chamber lid 40 is in a closed position.

In an exemplary embodiment, the small hive beetle trap attachment 10 may be made with an injection molding or a blister pack process. The small hive beetle trap attachment 10 may be made from clear or opaque polypropylene or other similar material. “See through” material may allow inspection for trapped beetles without removing the small hive beetle trap attachment 10 from the bee hive 58.

It should be understood, of course, that the foregoing relates to exemplary embodiments of the invention and that modifications may be made without departing from the spirit and scope of the invention as set forth in the following claims.

What is claimed is:

1. A beetle trap attachment comprising:
a body;
a bait chamber attached to the body;
an oil reservoir attached to the body disposed adjacent to the bait chamber;
a plurality of spring action arms configured for attaching to a bee hive frame attached to the body and disposed outwardly from the body; and
at least one slot configured for allowing beetles to enter the at least one slot, the at least one slot disposed on the body adjacent to the bait chamber.

2. The beetle trap attachment of claim 1, wherein the bait chamber, with separate lid, includes at least one fume escape sized such that living small hive beetles may be retained as bait to attract more of the beetles into the oil reservoir.

3. The beetle trap attachment of claim 1, wherein the body includes a tab configured to lift the beetle trap attachment from a frame of the bee hive.

4. The beetle trap attachment of claim 1, wherein the plurality of spring action arms are disposed at an angle from the body.

5. The beetle trap attachment of claim 1, wherein the body has a lid.

6. The beetle trap attachment of claim 1, wherein the oil reservoir includes partitions.

7. The beetle trap attachment of claim 1, including a wall attached to the body configured to guide beetles into the at least one slot.

8. The beetle trap attachment of claim 1, wherein the beetle trap attachment is composed of material that a user may see through.

9. The beetle trap attachment of claim 1, wherein the bait chamber includes a tab for opening the bait chamber.

10. The beetle trap attachment of claim 5 including a lip inside and completely around the beetle entrance slot/s configured to prevent beetles from escaping,
wherein the beetle trap attachment is configured such that a top surface of the body is lower than a top surface of the bee hive frame, and
wherein the beetle trap attachment has walls on a plurality of ends which form a pocket lower than the top surface of the bee hive frame.
